(19) United States
(12) Patent Application Publication
(10) Pub. No.: US 2024/0370157 A1
(43) Pub. Date: Nov. 7, 2024

(54) INTERACTION METHOD, INTERACTION APPARATUS, ELECTRONIC DEVICE, AND COMPUTER-READABLE STORAGE MEDIUM

(71) Applicant: Beijing Zitiao Network Technology Co., Ltd., Beijing (CN)

(72) Inventor: Weiyi CHANG, Beijing (CN)

(21) Appl. No.: 18/572,160

(22) PCT Filed: Oct. 28, 2022
(86) PCT No.: PCT/CN2022/128263

§ 371 Date: Dec. 19, 2023

(30) Foreign Application Priority Data
Oct. 28, 2021 (CN) 202111265650.5

(51) Int. Cl. G06F 3/0486; G06F 3/16

(52) U.S. Cl. CPC G06F 3/0486; G06F 3/165; G06F 3/167

(57) ABSTRACT

Some embodiments of the present disclosure provide an interaction method, an interaction apparatus, an electronic device, and a computer readable storage medium. The interaction method comprises: displaying first display content corresponding to a first type in a first display page of a target application; in response to a triggering operation, jumping from the first display page to a second display page of the target application; and displaying second display content corresponding to a second type in the second display page, the first display content of the first type being one of a data stream corresponding to visual content and a data stream corresponding to auditory content, the second display content of the second type being the other of a data stream corresponding to visual content and a data stream corresponding to auditory content, and at least one item of auditory content data in the data stream corresponding to auditory content being different from auditory content data corresponding to visual content data in the data stream corresponding to visual content The present disclosure provides an interaction method which includes displaying first display content corresponding to a first type in a first display interface; switching from the first display interface to a second display interface in response to a triggering; displaying second display content corresponding to a second type in the second display interface. The first display content of the first type is one of a data stream corresponding to visual content and a data stream corresponding to auditory content, the second display content of the second type is the other one. At least one item of auditory content data in the data stream corresponding to auditory content is different from auditory content data corresponding to visual content data in the data stream corresponding to visual content.

### CROSS REFERENCE TO RELATED APPLICATION

The present application claims the priority of Chinese Patent Application No. 202111265650.5 filed on Oct. 28, 2021, which is hereby incorporated by reference in its entirety as part of the present application.

### TECHNICAL FIELD

Embodiments of the present disclosure relate to an interaction method, an interaction device, an electronic device and a computer-readable storage medium.

### BACKGROUND

The consumption form of related video application programs only involves visual data streams, such as providing short video data, etc., and a user need to handheld an electronic device to perform an interaction operation during use, which fails to meet the entertainment need in a situation where the user is not convenient to refresh videos with the handheld device. For example, after the user changes from a resting state to a driving state, it is not convenient to operate a display screen of a terminal device for an interaction operation, resulting in that the user fails to continue to rely on the application program to obtain an entertainment experience. In this case, the user has to stop using such visual application programs. Therefore, related video application programs cannot satisfy the accompanying needs of the users in various situations.

### SUMMARY

The present disclosure relates to an interaction method, an interaction device, an electronic device and a computer-readable storage medium, which can implement switching between interfaces showing two types of data streams and satisfy entertainment and accompanying needs of users in various scenarios.

According to an aspect of the present disclosure, an interaction method is provided. The method includes: displaying first display content corresponding to a first type in a first display interface of a target application; switching from the first display interface to a second display interface of the target application in response to a triggering operation; and displaying second display content corresponding to a second type in the second display interface, wherein the first display content of the first type is one of a data stream corresponding to visual content and a data stream corresponding to auditory content, the second display content of the second type is the other of the data stream corresponding to visual content and the data stream corresponding to auditory content, and wherein at least one item of auditory content data in the data stream corresponding to auditory content is different from auditory content data corresponding to visual content data in the data stream corresponding to visual content.

According to some embodiments of the present disclosure, the first display content of the first type is the data stream corresponding to visual content, the second display content of the second type is the data stream corresponding to auditory content, and switching from the first display interface to the second display interface is a conversion from the data stream corresponding to visual content to the data stream corresponding to auditory content.

According to some embodiments of the present disclosure, the method further includes: determining the second display content according to a background audio associated with the first display content of the first type; or determining the second display content according to play information corresponding to the first display interface.

According to some embodiments of the present disclosure, the method further includes: directly determining the second display content in response to the triggering operation, wherein there is no corresponding relationship between the second display content and the first display content.

According to some embodiments of the present disclosure, the second display content is a predetermined audio, and the predetermined audio includes the background audio.

According to some embodiments of the present disclosure, the determining the second display content according to a background audio associated with the first display content of the first type includes: acquiring complete song information of the background audio, and determining the complete song information as the second display content.

According to some embodiments of the present disclosure, the displaying second display content corresponding to a second type in the second display interface includes: acquiring a recommended audio data stream; and determining the recommended audio data stream as the second display content, and automatically playing the recommended audio data stream in the second display interface.

According to some embodiments of the present disclosure, the second type includes N sub-categories of audio data streams, N is an integer greater than 1, and the method further includes: determining one of the N sub-categories of audio data streams as the second display content in response to the triggering operation.

According to some embodiments of the present disclosure, the method further includes: switching to play the N sub-categories of audio data streams in the second display interface in response to a preset operation for the second display interface; or displaying a first movable control on the second display interface, and switching to play the N sub-categories of audio data streams in the second display interface in response to a dragging operation for the first movable control.

According to some embodiments of the present disclosure, the method further includes: when current display content is the data stream corresponding to auditory content, controlling the current display content and/or the data stream corresponding to auditory content in response to obtained voice control command.

According to some embodiments of the present disclosure, a second movable control is displayed in the first display interface, the switching from the first display interface to a second display interface in response to a triggering operation includes: acquiring a first dragging operation for the second movable control; and determining to trigger interface switching in response to the first dragging operation, wherein the interface switching correspond to switch from the first display interface to the second display interface.

According to some embodiments of the present disclosure, the determining to trigger interface switching in response to the first dragging operation includes: determining to trigger the interface switching in response to the first dragging operation corresponding to dragging the second movable control to a target area in the first display interface.

According to some embodiments of the present disclosure, the target area includes at least one first predetermined area located in the first display interface.

According to some embodiments of the present disclosure, the method further includes: acquiring a second dragging operation for a third movable control in the second display interface after displaying the second display content in the second display interface; and in response to the second dragging operation corresponding to dragging the third movable control to a second predetermined area in the second display interface, switching to the first display interface and continuing to display the first display content in the first display interface.

According to some embodiments of the present disclosure, the second predetermined area corresponds to a position where the second movable control is displayed in the first display interface.

According to some embodiments of the present disclosure, an operable control is displayed in the first display interface, the switching from the first display interface to a second display interface in response to a triggering operation includes: determining to trigger interface switching in response to an operation duration for the operable control satisfying a time threshold, wherein the interface switching corresponds to switch from the first display interface to the second display interface.

According to another aspect of the present disclosure, an interaction device is provided. The interaction device includes: a display unit configured to: display first display content corresponding to a first type in a first display interface of a target application; and a processing unit configured to: switch from the first display interface to a second display interface of the target application in response to a triggering operation. The display unit is further configured to: display second display content corresponding to a second type in the second display interface, wherein the first display content of the first type is one of a data stream corresponding to visual content and a data stream corresponding to auditory content, the second display content of the second type is the other of the data stream corresponding to visual content and the data stream corresponding to auditory content, and wherein at least one item of auditory content data in the data stream corresponding to auditory content is different from auditory content data corresponding to visual content data in the data stream corresponding to visual content.

According to some embodiments of the present disclosure, the first display content of the first type is the data stream corresponding to visual content, the second display content of the second type is the data stream corresponding to auditory content, and switching from the first display interface to the second display interface is a conversion from the data stream corresponding to visual content to the data stream corresponding to auditory content.

According to some embodiments of the present disclosure, the processing unit is further configured to: determine the second display content according to a background audio associated with the first display content of the first type; or determine the second display content according to play information corresponding to the first display interface.

According to some embodiments of the present disclosure, the processing unit is further configured to: directly determine the second display content in response to the triggering operation, wherein there is no corresponding relationship between the second display content and the first display content.

According to some embodiments of the present disclosure, the second display content is a predetermined audio, and the predetermined audio includes the background audio.

According to some embodiments of the present disclosure, for determining the second display content according to a background audio associated with the first display content of the first type, the processing unit is configured to: acquire complete song information of the background audio, and determine the complete song information as the second display content.

According to some embodiments of the present disclosure, for displaying second display content corresponding to a second type in the second display interface, the processing unit is configured to: acquire a recommended audio data stream; and determine the recommended audio data stream as the second display content, and automatically play the recommended audio data stream in the second display interface.

According to some embodiments of the present disclosure, the second type includes N sub-categories of audio data streams, N is an integer greater than 1, and the processing unit is further configured to: determine one of the N sub-categories of audio data streams as the second display content in response to the triggering operation.

According to some embodiments of the present disclosure, the processing unit is further configured to: switch to play the N sub-categories of audio data streams in the second display interface in response to a preset operation for the second display interface; or display a first movable control on the second display interface, and switch to play the N sub-categories of audio data streams in the second display interface in response to a dragging operation for the first movable control.

According to some embodiments of the present disclosure, the processing unit is further configured to: when current display content is the data stream corresponding to auditory content, control the current display content and/or the data stream corresponding to auditory content in response to obtained voice control command.

According to some embodiments of the present disclosure, a second movable control is displayed in the first display interface. For switching from the first display interface to a second display interface in response to a triggering operation, the processing unit is configured to: acquire a first dragging operation for the second movable control; and determine to trigger interface switching in response to the first dragging operation, wherein the interface switching correspond to switch from the first display interface to the second display interface.

According to some embodiments of the present disclosure, the determining to trigger interface switching in response to the first dragging operation includes: determining to trigger the interface switching in response to the first dragging operation corresponding to dragging the second movable control to a target area in the first display interface.

According to some embodiments of the present disclosure, the target area includes at least one first predetermined area located in the first display interface.

According to some embodiments of the present disclosure, the processing unit is further configured to: acquire a second dragging operation for a third movable control in the second display interface after displaying the second display content in the second display interface; and in response to the second dragging operation corresponding to dragging the third movable control to a second predetermined area in the second display interface, switch to the first display interface and continuing to display the first display content in the first display interface.

According to some embodiments of the present disclosure, the second predetermined area corresponds to a position where the second movable control is displayed in the first display interface.

According to some embodiments of the present disclosure, an operable control is displayed in the first display interface. For switching from the first display interface to a second display interface in response to a triggering operation, the processing unit is configured to: determine to trigger interface switching in response to an operation duration for the operable control satisfying a time threshold, wherein the interface switching corresponds to switch from the first display interface to the second display interface.

According to another aspect of the present disclosure, an electronic device is provided. The electronic device includes a memory, a processor and a computer program stored in the memory, wherein the processor executes the computer program to implement the steps of the interaction method according to the present disclosure.

According to another aspect of the present disclosure, a computer-readable storage medium is provided. The computer-readable storage medium has a computer program stored thereon, wherein the computer program, when executed by a processor, implements the steps of the interaction method according to the present disclosure.

By utilizing the interaction method, the interaction device, the electronic device and the computer-readable storage medium provided according to the embodiments of the present disclosure, for a target application, the steps of switching from a first display interface displaying first display content of a first type to a second display interface in response to a triggering operation, and displaying second display content of a second type in the second display interface after switching can be implemented, wherein the first display content of the first type is one of a data stream corresponding to visual content and a data stream corresponding to auditory content, and the second display content of the second type is the other one of the data stream corresponding to visual content and the data stream corresponding to auditory content, such that the interaction method according to the embodiments of the present disclosure can realize the effects of displaying both auditory and visual data streams in the same target application and switching between the two types of data streams through the triggering operation of the user, such that the application program can satisfy the accompanying needs of the users in various scenarios, and thus, the entertainment and user experience of the application program can be improved.

### BRIEF DESCRIPTION OF THE DRAWINGS

In order to provide a clearer explanation of the disclosed embodiments or technical solutions in the prior art, a brief introduction will be given to the accompanying drawings required in the description of the embodiments or prior art. It is obvious that the accompanying drawings in the following description are only some embodiments of the present disclosure. For ordinary technical personnel in the art, other accompanying drawings can be obtained based on these drawings without any creative effort.

FIG. 1 shows a schematic flowchart of an interaction method according to some embodiments of the present disclosure;

FIG. 2 shows a schematic diagram of a mobile terminal implementing the interaction method according to some embodiments of the present disclosure;

FIG. 3 shows a schematic diagram of an application scenario for implementing the method according to some embodiments of the present disclosure;

FIG. 4 shows a schematic diagram of a first display interface including a second movable control;

FIG. 5A shows a process diagram of a dragging operation according to some embodiments of the present disclosure;

FIG. 5B shows a schematic diagram of a target area according to some embodiments of the present disclosure;

FIG. 6A shows another schematic diagram of a first display interface according to an embodiment of the present disclosure;

FIG. 6B shows a schematic diagram of a pop-up interface including a touch control;

FIG. 7 shows a schematic diagram of a second display interface according to some embodiments of the present disclosure;

FIG. 8 shows another schematic diagram of a second display interface according to some embodiments of the present disclosure;

FIG. 9 shows a schematic diagram of a second display interface including a third movable control;

FIG. 10 shows a schematic block diagram of an interaction device according to some embodiments of the present disclosure;

FIG. 11 shows a schematic block diagram of an electronic device according to some embodiments of the present disclosure;

FIG. 12 shows an architectural schematic diagram of an exemplary computing device according to some embodiments of the present disclosure; and

FIG. 13 shows a schematic block diagram of a computer-readable storage medium according to some embodiments of the present disclosure.

### DETAILED DESCRIPTION

The following will provide a clear and complete description of the technical solution in the disclosed embodiments in conjunction with the accompanying drawings. Obviously, the described embodiments are only a portion of the embodiments disclosed in this disclosure, and not all of them. Based on the embodiments in this disclosure, all other embodiments obtained by ordinary technical personnel in the art without the creative labor belong to the scope of protection in this disclosure.

The terms “first”, “second”, and similar terms used in this disclosure do not indicate any order, quantity, or importance, but are only used to distinguish different components. Similarly, words such as “including” or “comprising” refer to the components or objects that appear before the word, including the components or objects listed after the word and their equivalents, without excluding other components or objects. Words such as “connection” or “connecting” are not limited to physical or mechanical connections, but can include electrical connections, whether direct or indirect.

In the related art, the consumption form of video application programs (APP, which may also be called application products) is only limited to video content, such as short videos, etc., and in a process of using such applications, the user needs to operate with a handheld electronic device, which cannot satisfy the accompanying need in a scenario where the user is not convenient to interact with the handheld device. For example, when the user is in a resting state, the user can be entertained based on a video application program, and implement interaction processes such as refreshing short videos by operating the device, so as to obtain an entertainment experience. However, when the user changes from the resting state to a situation where it is not convenient to continue watching videos or operating the device for interaction, such as driving a car, cooking, etc., the user must stop using such video application program. If the user in an inconvenient operation state desires to continue to obtain the entertainment experience, the user operates the device and opens other audio application programs, such as a music application, to satisfy the accompanying and entertainment needs. This switching operation between the application programs affects the use experience of the user and the consistency of consumption content cannot be maintained. For example, after the user ends the driving mode, the user needs to switch back to the video application program. Therefore, it is necessary to upgrade related product functions to satisfy the needs of users in different application scenarios.

Some embodiments of the present disclosure provide an interaction method for implementing interactive switching between two application scenarios and content forms in a target application, for example, switching between a first application scenario (data stream of visual content) and a second application scenario (data stream of auditory content) based on a triggering operation of a user, so as to satisfy the accompanying needs of the user in different application scenarios, for example, satisfying the accompanying needs in scenes (such as driving) that are inconvenient for visual consumption of user. By the interaction method according to some embodiments of the present disclosure, the user can switch between different types of display interfaces by the triggering operations, such that the entertainment forms of the related application products are enriched, which facilitates the improvement the entertainment experience of interaction between the user and, for example, a terminal device.

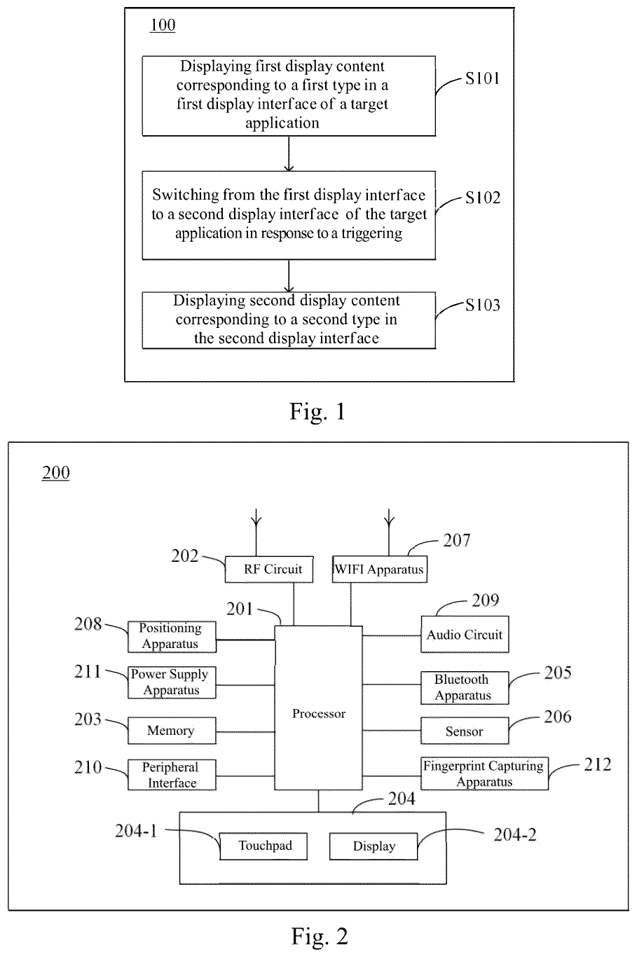

FIG. 1 shows a schematic flowchart of an interaction method according to some embodiments of the present disclosure. As shown in FIG. 1, an interaction method 100 according to some embodiments of the present disclosure may include steps S101-S103.

Firstly, in the interaction method according to some embodiments of the present disclosure, at step S101, first display content corresponding to a first type is displayed in a first display interface of a target application. At step S102, in response to a triggering operation, switching from the first display interface to a second display interface of the target application is performed. As an example, the target application may be an application program installed in an electronic device, and the first display interface and the second display interface belong to the same target application. As an example, the above-mentioned triggering operation for triggering interface switching may refer to triggering the electronic device to switch from the first display interface currently displayed to the second display interface to be displayed, wherein the type of second display content displayed on the second display interface is different from first display content displayed on the first display interface. Specifically, triggering may be understood as a starting point that urges the terminal device to perform a certain process or operation. It can be understood that a triggering event that triggers the interface switching may also trigger other operations synchronously, which are not limited here.

Next, at step S103, the second display content corresponding to a second type is displayed in the second display interface.

Specifically, according to some embodiments of the present disclosure, the first display content of the first type may be one of a data stream corresponding to visual content and a data stream corresponding to auditory content, and the second display content of the second type is the other one of the data stream corresponding to visual content and the data stream corresponding to auditory content, and at least one item of auditory content data in the data stream corresponding to auditory content is different from auditory content data corresponding to visual content data in the data stream corresponding to visual content. In addition, the first display interface and the second display interface correspond to the same application program. A process of how to determine the second display content to be displayed on the second display interface will be described in detail below in combination with the embodiments.

As some implementations, the first display content of the first type can be the data stream corresponding to visual content, and the second display content of the second type is the data stream corresponding to auditory content, that is to say, the above-mentioned switching from the first display interface to the second display interface is a conversion from the data stream corresponding to visual content to the data stream corresponding to auditory content.

The above-mentioned data stream corresponding to visual content may be or may not be associated with the data stream corresponding to auditory content. As an example, the data stream corresponding to visual content may be video data such as a short video, etc. In addition, it can be understood that the data stream corresponding to visual content may also include an audio data stream, that is, the video data includes both image content and audio content. The data stream corresponding to auditory content may be a data stream of content such as music, a radio, a broadcast, etc. That is to say, the data stream corresponding to visual content may refer to data content for visual consumption by the user, while the data stream corresponding to auditory content may refer to data content for auditory consumption by the user. As an example, the data stream corresponding to auditory content may be applied to, for example, situations where it is inconvenient for the user to watch or operate a terminal display screen, for example, during driving.

It can be understood that the term “displaying” herein may refer to operations such as displaying a video and an image, or playing an audio, to display information to users, for example. For example, displaying a data stream corresponding to visual content may be understood as displaying visual consumption content such as a video and a picture, and at the same time playing an audio associated with the displayed visual content, such as background music, dubbing and the like, through a speaker, for example. For another example, displaying a data stream corresponding to auditory content may be understood as playing auditory consumption content such as a radio, music and an electronic novel.

It can be understood that the user referred to herein may refer to an operator capable of operating the electronic device, and the user may be specific to the electronic device, for example, by logging in account information in the application program of the electronic device. In a login process, the device may send account information to a server (for example, corresponding to a platform or a provider of the application program installed on the electronic device), and the account information can be in the form of a name, an account number, a password, an account identifier, etc., which is not limited here. As an example, a video playing application program may be installed on the electronic device, and the electronic device receives the account information input into the video playing application program by the user, so as to implement the account login process. In addition, the electronic device may also send the received account information to the server, and receive data sent by the server for a logged-in account. For example, the data may include video data to be played on the electronic device and related indication information for implementing a video playing function.

As some examples, for an application program (for example, which may be called a comprehensive application program) that implements the interaction method according to the embodiment of the present disclosure so as to implement the switching between two types of interaction content, data streams of visual content (such as short videos, long videos, pictures and other types of entertainment content that require visual perception of the user) can be displayed in the first display interface. In addition, it can be understood that the first display interface can also display audio data streams, such as background music of a video, while displaying, for example, video data streams. Based on the first display interface of this comprehensive application program, the user can obtain a visual entertainment experience, and implement interactions such as refreshing videos, giving a like and comments through interaction operations. Next, the user may change to a scenario where the user cannot continue to consume visual content, such as driving or cooking, or if the user wants to suspend visual consumption to relieve visual fatigue, the user can switch a comprehensive application program from the first display interface to the second display interface through the above-mentioned triggering operation, so as to obtain a data stream of auditory content and continuously get entertainment accompanying. For example, the user may want to listen to a radio to be accompanied in a driving process when driving, and may want to listen to music when cooking. In the interaction method according to the embodiment of the present disclosure, the user can switch between the above-mentioned two types of consumption content based on a simple triggering operation, and the operation is simple and is carried out in the same application program, such that the user is saved from performing complicated operations of switching between different applications; and the switching in the same application program can also ensure the continuity of the consumption content of the user, for example, when the user resumes consuming visual content, the user can switch to continue to play the previous visual data stream through a similar triggering operation, which facilitates ensuring the coherence and consistency of the interaction content.

Next, an exemplary electronic device implementing the interaction method according to the embodiment of the present disclosure will be described. For example, the electronic device may be a mobile terminal, a desktop computer, a tablet computer, a personal computer (PC), a personal digital assistant (PDA), a smartwatch, a netbook, a wearable electronic device, an Augmented Reality (AR) device, etc., in which an application program can be installed and an icon of the application program be displayed, and the specific form of the electronic device is not limited by the present disclosure.

In at least some embodiments, the interaction method according to the embodiment of the present disclosure may be implemented in a mobile terminal 200 such as in FIG. 2.

As shown in FIG. 2, the mobile terminal 200 may specifically include: a processor 201, a radio frequency (RF) circuit 202, a memory 203, a touch screen 204, a Bluetooth apparatus 205, one or more sensors 206, a wireless fidelity (WI-FI) apparatus 207, a positioning apparatus 208, an audio circuit 209, a peripheral interface 210 and a power supply apparatus 211 and other components. These components may communicate with one another through one or more communication buses or signal lines (not shown in FIG. 2). It may be understood by those skilled in the art that a hardware structure shown in FIG. 2 does not constitute a limitation on the mobile terminal, and the mobile terminal 200 may include more or less components than shown, or a combination of some components, or a different component arrangement.

The various components of the mobile terminal 200 will be described in detail below in conjunction with FIG. 2.

Firstly, the processor 201 is a control center of the mobile terminal 200, which is connected with various parts of the mobile terminal 200 by various interfaces and lines, and executes various functions and processing data of the mobile terminal 200 by running or executing application programs stored in the memory 203 and calling data stored in the memory 203. In some embodiments, the processor 201 may include one or more processing units. By way of example, the processor 201 may be various processor chips.

The RF circuit 202 may be configured to receive and send wireless signals in a process of sending and receiving information or talking. In particular, the RF circuit 202 may receive downlink data from a base station and send the downlink data to the processor 201 for processing, and additionally send involved uplink data to the base station. Generally, the RF circuit includes, but is not limited to, an antenna, at least one amplifier, a transceiver, a coupler, a low noise amplifier, a duplexer, etc. In addition, the RF circuit 202 may also communicate with other devices through wireless communication. The wireless communication may use any communication standard or protocol, including but not limited to a global system for mobile communications, a general packet radio service, code division multiple access, wideband code division multiple access, long term evolution, E-mail, a short message service, etc.

The memory 203 is configured to store application programs and related data, and the processor 201 executes various functions and data processing of the mobile terminal 200 by running the application programs and the data stored in the memory 203. The memory 203 mainly includes a storage program area and a storage data area, wherein the storage program area may store an operating system and an application program required by at least one function (for example, an audio data playing function, a video data playing function); the storage data area may store data (e.g., audio data, video data, playback record information, etc.) created according to the use of the mobile terminal 200. In addition, the memory 203 may include a high-speed random access memory (RAM), and may also include nonvolatile memories, such as a disk memory device, a flash memory device or other volatile solid-state memory devices. The memory 203 may store various operating systems. The above-mentioned memory 203 may be independent and connected to the processor 201 through the communication bus. In addition, the memory 203 may be integrated with the processor 203.

The touch screen 204 may specifically include a touchpad 204-1 and a display 204-2.

The touchpad 204-1 may capture touch operations (alternatively referred to as touch events) on or near the touchpad 204-1 by a user of the mobile terminal 200, such as an operation on or near the trackpad 204-1 by a user using a finger, a stylus, or any suitable object, and send captured touch information to another device (e.g., the processor 201). The touch event of the user near the touchpad 204-1 may be called floating touch. The floating touch may mean that the user does not need to directly touch the touchpad 204-1 in order to select, move or drag an object (for example, an icon), but rather merely being in proximity to the device in order to perform a desired function. In addition, the touchpad 204-1 may be implemented as various types, such as resistive, capacitive, infrared and surface acoustic wave touchpads.

The display (or called a display screen) 204-2 may be configured to display information input by the user or information provided to the user and various menus of the mobile terminal 200. The display 204-2 may be configured in the form of a liquid crystal display, an organic light emitting diode, or the like. The touchpad 204-1 may be overlaid on the display 204-2. When the touchpad 204-1 detects a touch event on or near it, the touchpad delivers the touch event to the processor 201 to determine parameters of the touch event, and then the processor 201 may provide corresponding output data, such as video data or audio data, on the display 204-2 according to the parameters of the touch event. Although in FIG. 2 the touchpad 204-1 and the display screen 204-2 implement input and output functions of the mobile terminal 200 as two independent components, in some embodiments, the touchpad 204-1 and the display screen 204-2 may be integrated to implement the input and output functions of the mobile terminal 200. It can be understood that the touch screen 204 is made of multiple layers of materials that are stacked, only the touchpad (layer) and the display screen (layer) are shown in FIG. 2, and other layers are not described in FIG. 2. In addition, the touchpad 204-1 may be configured on a front surface of the mobile terminal 200 in the form of a full panel manner, and the display screen 204-2 may also be configured on the front surface of the mobile terminal 200 in the form of a full panel manner, such that a frameless structure may be implemented on the front surface of the terminal device.

Further, the mobile terminal 200 may also have a fingerprint recognition function. For example, a fingerprint capturing device 212 may be configured on a back surface of the mobile terminal 200 (for example, below a rear camera), or the fingerprint capturing device 212 may be configured on the front surface of the mobile terminal 200 (for example, below the touch screen 204). For another example, the fingerprint capturing device 212 may be configured in the touch screen 204 to implement the fingerprint recognition function, that is, the fingerprint capturing device 212 may be integrated with the touch screen 204 to implement the fingerprint recognition function of the mobile terminal 200. In this case, the fingerprint capturing device 212 is configured in the touch screen 204, and may be a part of the touch screen 204 or configured in the touch screen 204 in other ways. A main component of the fingerprint capturing device 212 may be a fingerprint sensor, which may adopt any type of sensing technology, including but not limited to optical, capacitive, piezoelectric or ultrasonic sensing technologies.

The mobile terminal 200 may also include a Bluetooth apparatus 205 for implementing data exchange between the mobile terminal 200 and other short-distance devices (such as a mobile phone, a smartwatch, etc.). Specifically, the Bluetooth apparatus 205 may be an integrated circuit or a Bluetooth chip, etc.

The mobile terminal 200 may further include at least one sensor 206, such as an optical sensor, a motion sensor, and other sensors. Specifically, the optical sensor may include an ambient light sensor and a proximity sensor, wherein the ambient light sensor may adjust the brightness of the display of the touch screen 204 according to the brightness of ambient light, and the proximity sensor may turn off a power supply of the display when the mobile terminal 200 moves to the ear. As one type of motion sensor, an accelerometer sensor can detect the magnitude of acceleration in all directions (typically in three axes), and can detect the magnitude and direction of gravity at rest, so as to be used for applications of recognizing a gesture of the mobile phone (such as portrait and landscape screen switching, related games, magnetometer gesture calibration), vibration recognition related functions (such as pedometers and taps) and the like. The mobile terminal 200 may also be equipped with other sensors, such as a gyroscope, a barometer, a hygrometer, a thermometer, an infrared sensor, etc., which are not described in detail here.

The WI-FI apparatus 207 is configured to provide the mobile terminal 200 with network access following WI-FI related standards and protocols, and the mobile terminal 200 may have access to a WI-FI access point through the WI-FI apparatus 207, to further assist the user in receiving or sending data, such as sending and receiving emails, browsing web interfaces and accessing streaming media, thereby providing wireless broadband internet access to the user. In other examples, the WI-FI apparatus 207 may also be used as a WI-FI wireless access point, which may provide WI-FI network access for other devices.

The positioning apparatus 208 is configured to provide geographic location information for the mobile terminal 200. It can be understood that the positioning apparatus 208 may specifically be a receiver of a global positioning system (GPS), a BEIDOU satellite navigation system, a Russian GLONASS and other positioning systems. After receiving the geographic location information sent by the above-mentioned positioning system, the positioning apparatus 208 can, for example, send the information to the processor 201 for processing or send the information to the memory 203 for storage. In other examples, the positioning apparatus 208 may also be a receiver of an assisted global positioning system (AGPS), and the AGPS system assists the positioning apparatus 208 in completing ranging and positioning services by serving as an auxiliary server. In this case, the auxiliary positioning server communicates with a device such as a positioning apparatus 208 (e.g., a GPS receiver) of the mobile terminal 200 through a wireless communication network to provide positioning assistance. In other examples, the positioning apparatus 208 may also be a positioning technology based on the WI-FI access point. Since each WI-FI access point has one globally unique media access control (MAC) address and the terminal device may scan and collect broadcast signals of the surrounding WI-FI access points when WI-FI is turned on, the MAC address broadcast by the WI-FI access points can be obtained. The terminal device sends these data (for example, MAC addresses) that may mark the WI-FI access points to a location server through the wireless communication network, and the location server retrieves a geographic location of each WI-FI access point, and calculates the geographic location of the terminal device in combination with the strength of the WI-FI broadcast signal and sends the geographic location to the positioning apparatus 208 of the terminal device.

The audio circuit 209 may include, for example, a speaker and a microphone for providing an audio interface between a user and the mobile terminal 200. The audio circuit 209 may convert the received audio data into an electrical signal, and transmit the electrical signal to the speaker, which converts the electrical signal into a sound signal and outputs the sound signal. On the other hand, the microphone converts the collected sound signal into an electrical signal, the electrical signal is received by the audio circuit 209 and converted into audio data, and then the audio data is output to the RF circuit 202 to be sent to another device, for example, or the audio data is output to the memory 203 for further processing. As an example, a microphone may receive a voice command from a user in some cases, and transmit the obtained voice signal to the processor 201 for parsing a user instruction, and the processor 201 performs corresponding operations based on the parsed user instruction, thus implementing voice interaction with the user.

The peripheral interface 210 is configured to provide various interfaces for external input/output devices (for example, a keyboard, a mouse, an external display, an external memory, a subscriber identity module card). For example, it is connected with a mouse through a universal serial bus (USB) interface, and connected with a subscriber identification module (SIM) provided by a telecom operator through a metal contact on a card slot of the SIM. The peripheral interface 210 may be used to couple the above-mentioned external input/output peripheral devices to the processor 201 and the memory 203.

The mobile terminal 200 may also include a power supply apparatus 211 (for example, a battery and a power management chip) for supplying power to various components, and the battery may be logically connected with the processor 201 through the power management chip, such that the functions of charging, discharging and power consumption management are implemented through the power supply apparatus 211.

Although not shown in FIG. 2, the mobile terminal 200 may also include a camera (a front camera and/or a rear camera), a flashlight, a micro projector, a near field communication (NFC) apparatus, etc., which will not be described in detail here.

The interaction methods described in the following embodiments may all be implemented in the mobile terminal 200 with the above-mentioned hardware structure. Nevertheless, it can be understood that the interaction method described herein may also be applied to other suitable electronic devices, and is not limited to the mobile terminal described in conjunction with FIG. 2.

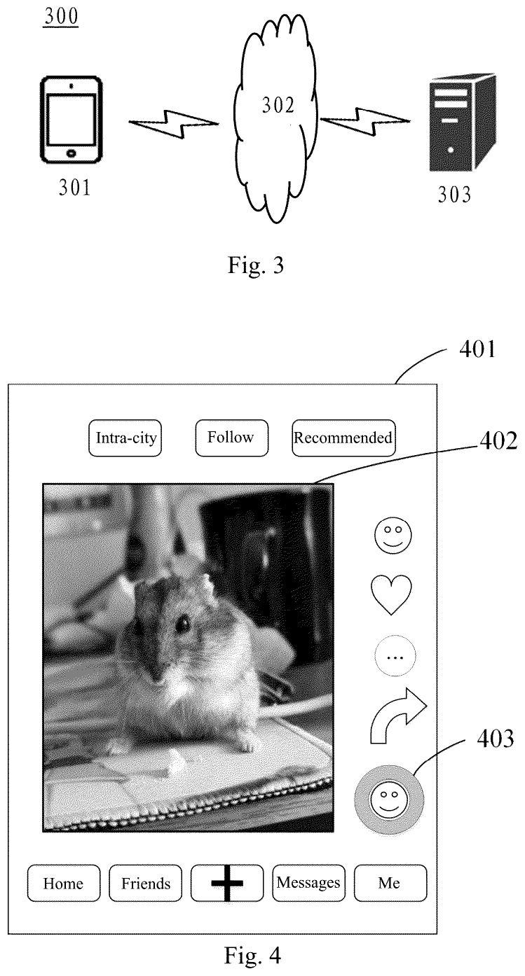

FIG. 3 shows a schematic diagram of an application scenario of a terminal device in an interaction system. As shown in FIG. 3, the interaction system may include, for example, a terminal device 301, a network 302, and a server 303.

The terminal device 301 may be a mobile terminal as shown or a fixed terminal, which performs data transmission with the server 303 through the network 302. Various application programs may be installed on the terminal device 301, such as a web browser application, a search application, a play application, a news information application, etc. In addition, the terminal device 301 includes an input/output apparatus, such that it may also receive user operations, such as touch and gesture operations through the touch screen, or voice operations through the microphone. Then, the terminal device 301 may generate a request message based on the received operation. Via the network 302, the terminal device 301 may send the above-mentioned request message to the server 303 and receive data returned by the server 303 in response to the request message. The terminal device 301 may display according to the data returned by the server 303, for example, display the received display data, such as a video or an image, on the display screen of the terminal device 301. In addition, the received data may also include other information, for example, a display time point and a duration of the video. Alternatively, the server 303 may directly send data to the terminal device 303 without receiving the request message, so as to perform corresponding processing on the terminal device 301.

The terminal device 301 may be in the form of hardware or software. When the terminal device 301 is in the form of hardware, it may be various devices which have a display screen and support program running. As described above, the terminal device 301 may be a mobile terminal shown, for example, which has the components described above in conjunction with FIG. 2. As other examples, the terminal device 301 may also be a smart TV, a tablet computer, an e-book reader, an MP4 (Moving Picture Experts Group Audio Layer IV) player, a laptop computer, a desktop computer, etc. When the terminal device 301 is in the form of software, it may be installed in the electronic devices listed above, and it may be implemented as multiple software or software modules (for example, software or software modules for providing distributed services) or as a single software or software module, which is not specifically limited here.

The network 302 may be a wired network or a wireless network, which is not limited here. The server 303 may provide various services, for example, receiving and caching a data stream sent by the terminal device 301. In addition, the server 303 may also receive the request message sent by the terminal device 301, analyze the request message, and send an analysis result (for example, a data stream corresponding to the request information) to the terminal device 301. Different servers may be arranged according to different application types. For example, the server 303 may be an instant messaging server, a payment application server, an information display application server, a resource management server, etc. It can be understood that the number of terminal devices 301, networks 302 and servers 303 shown in FIG. 3 is only for illustration. According to an actual application scenario, there may be any number of terminal devices, networks and servers.

Hereinafter, the interaction method provided according to some embodiments of the present disclosure will be described in detail by taking an interaction method of switching between two types of display interfaces as an example. As an example, in the embodiment described below, the first display content in the first display interface is a data stream corresponding to visual content, and the second display content is a data stream corresponding to auditory content, that is, switching from an interface for visual content consumption by a user to an interface for auditory content consumption by the user is performed. It can be understood that the application scenario of the interaction method according to the embodiments of the present disclosure is not limited to this.

According to some embodiments of the present disclosure, a second movable control is displayed in the first display interface. Specifically, the movable control may collect touch operations for the first movable control, to determine touch operation parameters based on the detected touch operation, such that corresponding responses can be made based on the determined touch operation parameters which may include, for example, a touch starting point, a dragging distance, a dragging direction, a touch duration and the like. For example, the movable control may be displayed on a display screen of the terminal device, and the user may select and drag the displayed control by touching or dragging, etc., and the terminal device receives a user operation based on the control and takes the user operation as user input information for implementing subsequent processing. As an example, the movable control may be implemented by various programming languages, for example, computer languages such as HTML and Js, which are not limited here.

For example, the movable control may be a control which is displayed on a display interface of an electronic device and may be displaced by dragging, and a user of the electronic device may select the control by clicking and drag the control to be displaced as user input information. As an example, the movable control may be displayed at any suitable position of the display interface, and may receive a dragging operation on a touchpad by a user. For example, the movable control may be displayed at an edge position in the first display interface, such as a lower left edge position or a lower right edge position.

According to some embodiments of the present disclosure, the switching from the first display interface to a second display interface in response to a triggering operation includes: acquiring a first dragging operation for the second movable control; determining to trigger interface switching in response to the first dragging operation, the interface switching corresponding to switching from the first display interface to the second display interface. Specifically, in response to the first dragging operation corresponding to dragging the second movable control to a target area in the first display interface, it is determined to trigger interface switching. As an example, the target area includes at least one first predetermined area located in the first display interface.

As an example, FIG. 4 shows a schematic diagram of a first display interface displaying a second movable control. A process of the triggering operation for triggering interface switching will be described below in conjunction with FIG. 4.

As shown in FIG. 4, the first display content 402 and the above-mentioned second movable control 403 are displayed in the first display interface 401. For example, the display interface may be displayed in full screen, that is, it completely covers the complete display screen of the mobile terminal. For another example, the display interface may also be displayed on the display screen of the terminal in the form of a pop-up, picture in picture, etc. In addition, the display interface may also cover only a part of the display screen, which is not limited here. Similarly, as shown in FIG. 4, the first display content 402 in the display interface 401 may occupy a part of the display interface, and in addition, the first display content 402 may also occupy the whole display interface, which is not limited here.

In the example shown in FIG. 4, the second movable control 403 is located at a lower right corner of the first display interface. Accordingly, the target area may be located at a middle potion of the first display interface and occupy a certain area. In other examples, the second movable control may also be located at other suitable positions. In addition, as shown in FIG. 4, other content may be displayed in the first display interface 401, such as icons and buttons shown at the top, bottom and right of the interface. The above-mentioned icons or buttons may be operable or inoperable, so as to implement functions related to the display interfaces, which are not limited here.

In the interaction method according to some embodiments of the present disclosure, for the first display interface displaying the second movable control, the dragging operation for the movable control may be detected in real time. The detection may be implemented, for example, by the touch screen or the touchpad. Triggering operation results of the movable control may include two situations, wherein the first operation result indicates that the movable control is dragged to the target area, and the second operation result indicates that the movable control is not dragged to the target area. As an example, in response to detecting the first operation result, interface switching may be performed corresponding to the first operation result, that is, switching to the second display interface is performed. In response to detecting the second operation result, the interface switching action may not be triggered corresponding to the second operation result.

In addition, according to some embodiments of the present disclosure, after the dragging operation for the second movable control is detected, transitional content may be displayed accordingly, such that the user can know a progress of the dragging operation. For example, the transitional content may be used to display an intermediate process associated with the second dragging operation for the first movable control, which is beneficial for the user to obtain a visualization effect for the dragging operation more intuitively according to the transitional content. For example, the transitional content may be displayed after the first dragging operation for the movable control 403 is detected and before switching to the second display interface is performed.

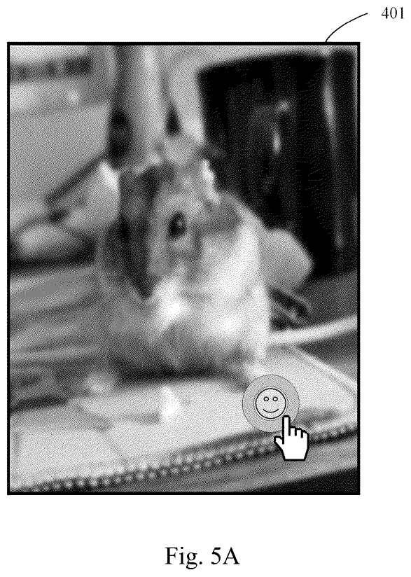

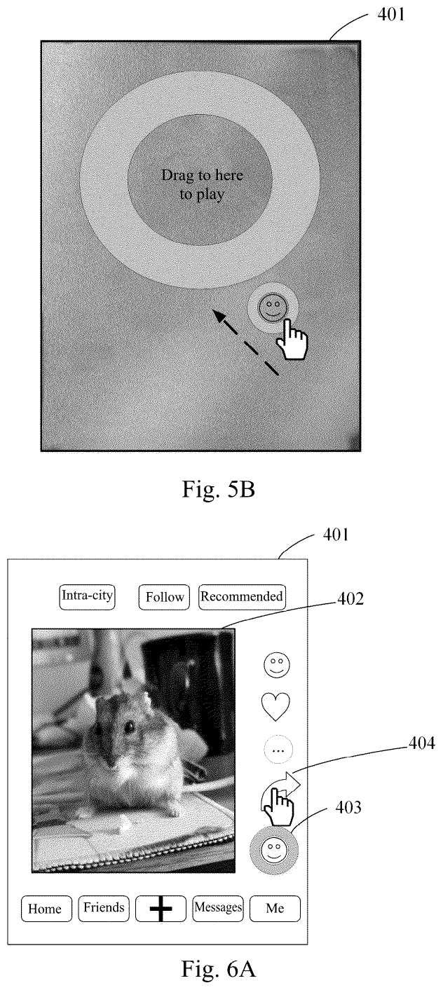

FIG. 5A shows a process diagram of a dragging operation according to some embodiments of the present disclosure. As shown in FIG. 5A, firstly, the transitional content includes the movable control 403, and the movable control is displayed in a mobile manner along with touch coordinates of the first dragging operation. With reference to the control and a hand icon shown in FIG. 5A, the user can understand a progress of the dragging operation based on both the control and the hand icon, for example, the control is displaced along with a dragging gesture of the user. As an example, the process of the control being displaced along with the dragging gesture of the user may be implemented by acquiring the touch coordinates for the touchpad in real time, that is, keeping the coordinates of the movable control displayed in the interface in synchronization with the touch coordinates.

In some embodiments according to the present disclosure, the transitional content may also include a background image, wherein the background image is obtained based on a first display content picture in the first display interface. As an implementation, the background image may be a picture of the first display content displayed at a time point when the dragging operation starts. As another implementation, as shown in FIG. 5A, the background image may be a blurred effect drawing of the picture of the first display content, for example, an image obtained after the above-mentioned frame image is blurred.

In other embodiments according to the present disclosure, the transitional content further includes a foreground image which may be obtained based on an interface color attribute of the second display interface, for example. As an example, the foreground image may refer to a mask layer. For example, a color of the mask layer is determined according to a color of a second display interface. For example, the color of the mask layer is consistent with the color of the second display interface, or the color changes from light to dark, and so on. For another example, in a case that the second display interface is colored, a color with a maximum value range through calculation may also be taken as the color of the foreground image. With respect to the foreground image, there may be other implementations.

According to some embodiments of the present disclosure, the first movable control being displayed in a mobile manner along with touch coordinates of the first dragging operation may include: changing when the first movable control is displayed in a mobile manner along with touch coordinates of the first dragging operation. For example, as shown in FIG. 5A, the second movable control may have the shape of a music turntable icon, and the music turntable icon displayed in the transitional content may move along with the touch coordinates of the first dragging operation in a process of the dragging operation for the movable control by the user, and the display effect of the music turntable icon may change in the moving process. As an implementation, the change may include changing a size of the music turntable icon, for example, the size becomes larger with displacement until it is the same as a size of the target area. As another implementation, the change may include a change in the shape of the music turntable icon, a change in a dynamic display effect, etc. In addition, the above-mentioned change may be implemented in other forms, which will not be described one by one.

In the above-mentioned embodiment in which the transitional content is displayed, in the process of the dragging operation for the movable control by the user, the transitional content can display the intermediate process corresponding to the dragging operation for the control and a corresponding display transition effect, which is beneficial for the user to obtain the visualization effect for the dragging operation more intuitively according to the transitional content; in addition, the transitional content also increases the interactivity of the dragging operation by the user and the man-machine interaction experience is improved.

According to some embodiments of the present disclosure, the displaying transitional content in the first display interface may include: displaying a shape of the target area in the first display interface; and determining to perform the interface switching action in response to the touch coordinates of the first dragging operation being within the shape of the target area. In the process of performing dragging operation for the movable control by the user, the coordinates of an operation point may be detected, and in response to determining that the coordinates of the operation point are located in the target area, it is determined to trigger interface switching.

According to some embodiments of the present disclosure, the second movable control may be displayed in a first predetermined shape, and the target area may be displayed in a second predetermined shape, wherein the first predetermined shape is associated with the second predetermined shape.

FIG. 5B shows a schematic diagram of a target area according to some embodiments of the present disclosure. In the example of FIG. 5B, the second movable control is displayed in the shape of a music turntable icon, and the target area is displayed in the shape of another music turntable icon. Specifically, a size of this other music turntable icon may be the same as a size of the target area.

Compared with the transitional content shown in FIG. 5A, the background image of the transitional content shown in FIG. 5B may be a grayscale image to highlight the shapes of the movable control and the target area. As an implementation, in the process of the dragging operation for the movable control by the user, the transitional content shown in FIG. 5A may be displayed first, and then the transitional content shown in FIG. 5B may be displayed as the dragging operation progresses. For example, after detecting that the user selects the movable control 403 shown in FIG. 4 by clicking, the background image of this transitional content is obtained and displayed as shown in FIG. 5A. Through this transitional content, the user can know that the dragging operation has been detected. Next, as the user drags the movable control to the target area, the transitional content shown in FIG. 5B may be displayed to further show a trend and progress of the dragging operation. According to the transitional content shown in FIG. 5B, the user can intuitively understand the range of the target area of the dragging operation, and can be guided to drag the movable control to the target area to implement interface switching, such that a situation that an operation failure is caused by the fact that the user fails to drag to the target area is avoided.

As an example, text information associated with the first dragging operation may also be displayed within the shape of the target area. For example, the content of the text information may be an illustrative description associated with the dragging operation, such as a text “Drag to play here” shown in FIG. 5B. This part of text information may serve as a guidance for the user operation, which guides the user to switch an operation process in text, thus prompting the user to have an interaction feeling and deepening the interaction experience.

As an example, it is also possible to change a display effect of the first predetermined shape in a process when the first movable control is displayed in a mobile manner along with touch coordinates of the first dragging operation, and to associate the display effect of the first predetermined shape with the second predetermined shape in a case that the touch coordinates of the first dragging operation reach the target area.

It can be understood that FIG. 5B only shows a situation that the displayed shape is a music turntable, and in other application situations, the shape of the movable control may be displayed as a book, and accordingly, the shape of the target area may be displayed as a desk lamp. Alternatively, the shape of the movable control is displayed as a radio, and accordingly, the shape of the target area may be displayed as something associated with the radio, etc. That is, the displayed shape of the target area may be associated with the displayed shape of the movable control as described above.

In addition, as described above, a change occurs when the movable control is displayed in a mobile manner along with touch coordinates of the dragging operation. As shown in FIG. 5B, in the process in which the movable control moves to the target area along with the touch coordinates, a size of the movable control may be changed, for example, the size of the movable control is continuously enlarged with the shortening of a distance from the target area, and when the movable control moves to the target area, it is enlarged to the same size as the music turntable corresponding to the target area. In addition, corresponding to the change of the movable control, the displayed shape of the target area may also change during the above-mentioned movement. For example, it may be a change in display color, a change in shape, or a change in the dynamic display effect. For example, the change of the displayed shape of the target area may be associated with the change of the movable control during the movement to form a visual echo effect, etc.

In the interaction method according to some embodiments of the present disclosure, in a process of implementing the switching of the display interfaces, the switching of display interfaces can be implemented based on the displayed movable control, such that the switching between different display interfaces may be implemented through the intuitive dragging operation, the interaction operation is simple, and a visual display effect, the implementation of operations and other aspects are more simple and intuitive, which facilitates the improvement of an operation experience of interaction between the user and, for example, a terminal device.

In addition, the interface switching implemented based on the dragging operation of the movable icon enables the user to switch between two types of display content only based on the simple and intuitive interface switching process, such that the operation interest of the user is enriched and the convenience of switching different types of interfaces is improved. For example, when the user consumes the data stream corresponding to visual content displayed in the first display interface, the user may need to switch to a situation where it is inconvenient to operate the terminal, such as a driving mode. Thus, the user may perform display interface switching based on the above-mentioned switching process, to directly switch from the current display interface corresponding to visual content to the switching display interface corresponding to auditory content, thereby continuously obtaining the accompanying and entertainment services of a product. Meanwhile, this is advantageous for increasing user stickiness for the application program and for maintaining the quantity of users.

It can be understood that in the interaction method provided according to some embodiments of the present disclosure, there may be other implementations for the triggering operation, and the present disclosure does not limit this.

For example, in some embodiments according to the present disclosure, an operable control is displayed in the first display interface, and the switching from the first display interface to a second display interface in response to a triggering operation includes: determining to trigger interface switching in response to an operation duration for the operable control satisfying a time threshold, the interface switching corresponding to switching from the first display interface to the second display interface. As an example, the operable control may be implemented as a control that can receive user operations, for example, a touch control, or as a control that can receive a selection operation, which is not limited here.

Taking the above-mentioned operable control as a touch control as an example, a touch control is displayed in the first display interface, and the switching from the first display interface to a second display interface in response to a triggering operation includes: determining to trigger interface switching in response to a touch duration (corresponding to the above-mentioned operation duration) for the touch control satisfying a time threshold, the interface switching corresponding to switching from the first display interface to the second display interface.

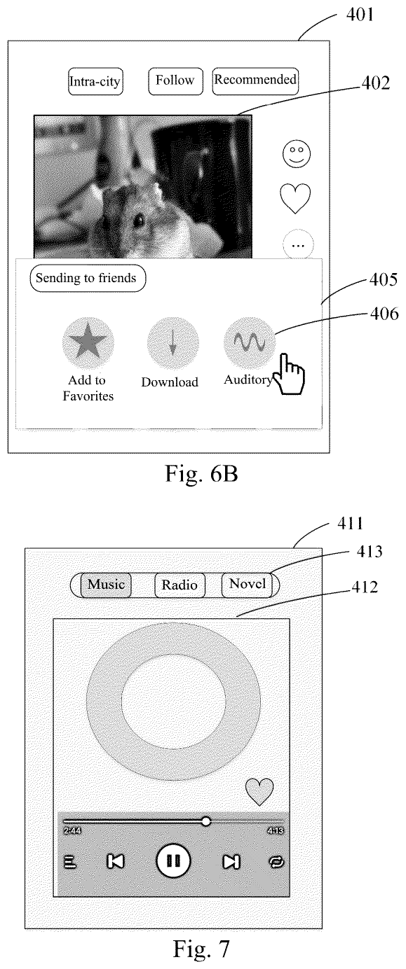

FIG. 6A shows another schematic diagram of a first display interface according to an embodiment of the present disclosure. Compared with the first display interface shown in FIG. 4, a sharing icon 404 is also shown in FIG. 6A. As an example, in response to a clicking operation by the user on the sharing icon 404, a further pop-up interface can be displayed for the user to perform an operation related to sharing, for example, the above-mentioned touch control is arranged in the pop-up interface.

As an example, FIG. 6B shows a schematic diagram of a pop-up interface including a touch control. As shown in FIG. 6B, a pop-up interface 405 schematically includes three touch icons, corresponding to a Favorites icon, a Download icon and an icon 406 for switching to auditory content. As an example, the icon 406 may be implemented as a control (corresponding to the above-mentioned touch control) capable of receiving the touch operation of the user. For example, the terminal device may receive a touch signal for the touch icon 406 via the touch panel, and obtain parameters associated with the touch operation, such as the touch duration, based on the touch signal. Further, in some embodiments according to the present disclosure, when it is determined that the touch duration for the touch control satisfies the time threshold, it is determined to trigger interface switching, that is, to switch from the first display interface corresponding to visual display content shown in FIG. 4 to the second display interface corresponding to auditory display content, such that the interface switching based on the touch duration for the touch control is implemented. For example, as shown in FIG. 6B, the user can implement the interface switching by continuously touching the icon 406, namely, the switching between two types of application scenarios.

As another example, the operable control can also be a control capable of receiving a selection operation. For example, the user may click and select the control by a location pointer (such as a mouse), and determine whether to trigger interface switching based on operation time for selecting the operable control.

The switching between the first display interface and the second display interface according to the embodiment of the present disclosure implemented based on the dragging operation of the movable control is described above in conjunction with FIGS. 5A and 5B, and then, the switching between the first display interface and the second display interface based on the touch duration of the touch control is described in conjunction with FIGS. 6A and 6B, such that the user can intuitively switch between two types of consumption content to satisfy the needs of the user in various application scenarios. It can be understood that the switching mode between two types of display interfaces according to the embodiment of the present disclosure is not limited to this, and other switching modes can also be adopted, which are not limited here.

Next, how to determine the second display content after interface switching will be described, wherein the second display content may be a data stream corresponding to auditory content.

According to some embodiments of the present disclosure, the interaction method may further include: determining the second display content according to a background audio associated with the first display content of the first type. That is, the second display content may be associated with the background audio of the first display content.

According to some embodiments of the present disclosure, the second display content may be a predetermined audio, the predetermined audio including a background audio. The determining the second display content according to a background audio associated with the first display content of the first type may include: acquiring complete song information of the background audio, and determining the complete song information as the second display content.

For example, the first display content in the first display interface may include a video, and the video may include background music, on which basis the second display content may be determined. For example, the above-mentioned background music may be a segment corresponding to a song, thus the second display content may be a partial segment or the entire content of the song.

According to some embodiments of the present disclosure, displaying a second display content corresponding to a second type in the second display interface includes: acquiring a recommended audio data stream; and taking the recommended audio data stream as the second display content, and automatically playing the recommended audio data stream in the second display interface. As an example, the recommended audio data stream here may be associated with the above-mentioned background audio. For example, a recommended data stream may be obtained based on the feature information of the background audio, wherein the feature information may include a music type of the background audio, such as folk songs, rock, etc., and then a recommended music list may be generated based on the music type and automatically played in the second display interface. In addition, the feature information may also include a source of the background audio, such as a theme song of a film and television drama, such that a recommended music list including other related music of the film and television drama can be generated and directly played on the second display interface.

Optionally, according to some embodiments of the present disclosure, the interaction method may further include: determining the second display content according to play information corresponding to the first display interface.

For example, the second display content may be determined according to associated data corresponding to current play information, historical play information, user attribute information and the like in the first display interface. As an example, the terminal device, for example, may collect current play information, historical play information, and user attribute information with user authorization. For example, historical play information may be information displayed on the switching display interface after the last interface switching is performed, such as songs played more times. For example, the user attribute information may be user feature information, user location information, etc., wherein the user location information may indicate the current location information of the terminal device, and the location information input by the user may also be previously stored location information. For example, in a case that the user attribute information includes the user location information, the corresponding second display content, such as location-related broadcast data, may be recommended based on the location information, thus achieving personalized display content recommendation on the second display interface after switching.

According to some embodiments of the present disclosure, the interaction method may further include: directly determining the second display content in response to the triggering operation, wherein there is no corresponding relationship between the second display content and the first display content, that is, the recommended audio data stream corresponding to the second display content is independent of the first content. As an example, the second display content may be randomly determined without any information. For example, the randomly recommended music may be played directly after switching to the second display interface, and for example, a randomly played music list may be generated according to the music playing heat, newly-put music and other content.

In a case that the first display interface corresponds to the data stream of visual content and the second display interface corresponds to the data stream of auditory content, the expression that there is no corresponding relationship between the second display content and the first display content can mean that the switched second display content is not the background music directly extracted from the video data played on the first display interface, but an audio data stream unrelated to the first display content. For example, the data stream of visual content may be a short video data stream, and the data stream of auditory content can be a radio data stream, a music data stream, a novel data stream, etc., instead of the background audio simply extracted from the first display interface. Based on the second display interface, the user can obtain continuous auditory consumption content and conduct corresponding interaction operations.

In some embodiments according to the present disclosure, at least one item of auditory content data in the data stream corresponding to auditory content is different from auditory data corresponding to visual content data in the data stream corresponding to visual content. As an example, the first audio content in the data stream of auditory content may be related to a video in the data stream of visual content. For example, the second display content may be determined to be a complete song of the background music according to the background music associated with the first display content of the first type. Next, the data stream content of the auditory content after the complete song may not have a corresponding relationship with the data stream of the visual content. For example, the recommended music list can continue to be played in the second display interface, or can be switched to, for example, a radio data stream based on an operation of the user, and there is no corresponding relationship between the content to be played later and the first display content on the first display interface.

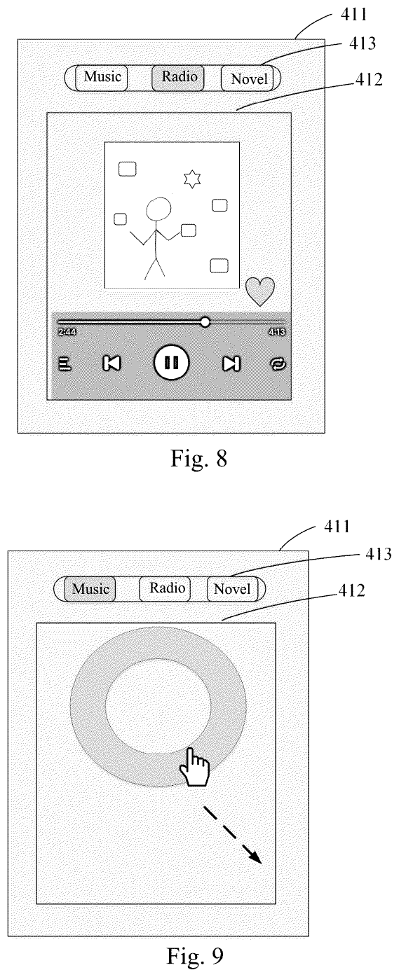

FIGS. 7 and 8 respectively show schematic diagrams of a second display interface after switching. As shown in FIGS. 7 and 8, a second display content 412 is displayed in a second display interface 411. According to some embodiments of the present disclosure, the second display content may include a plurality of sub-categories of display content. In a case that the second display content corresponds to the data stream of the auditory content, as an example, the second display content may include a sub-category of music, for example, such display content is used to provide a music data stream. As other examples, the second display content may also include sub-categories besides music, for example, a radio sub-category for providing broadcast data streams, a novel sub-category for providing novel reading resources, or a video call sub-category for implementing video communication data streams with other user devices, and the sub-categories of the second display content are not limited here.

For example, in FIGS. 7 and 8, the above three sub-categories (which also be called three tabs) are shown as category labels 413. In addition, the second display interface may also include other information related to play, such as a play progress at the bottom, which is not limited here.

In a case that the second type includes a plurality of sub-categories of audio data streams, the interaction method according to some embodiments of the present disclosure further includes: switching to play the N sub-categories of audio data streams in the second display interface in response to a preset operation for the second display interface. As an example, the above-mentioned preset operation may be a sliding operation for a category label. As an example, a category label 413 in the second display interface may be implemented as a sliding control capable of receiving a sliding touch operation. For example, the user can switch the display content of different categories by sliding the category tab 413. As an example, FIG. 7 shows a situation of a current display music tab, and the display content may be switched to a situation of a radio tab as shown in FIG. 8 by sliding 413 in FIG. 7.

Optionally, in a case that the second type includes a plurality of sub-categories of audio data streams, the interaction method according to some embodiments of the present disclosure further includes: displaying a first movable control on the second display interface; and switching to play the N sub-categories of audio data streams in the second display interface in response to a dragging operation for the first movable control. As an example, a movable control can be similarly provided in the second display interface as shown in FIGS. 7 and 8 for receiving the dragging operation of the user to implement the switching between the sub-categories. For the implementation of this movable control, reference can be made to the movable control and its operation process described above in conjunction with FIGS. 5A and 5B, which is not repeated here. As other examples, the switching between the audio data streams of the above-mentioned multiple sub-categories can also be implemented based on parameters such as a dragging angle and coordinates of a dragging end position for the first movable control.

In a case that the second type includes a plurality of sub-categories of audio data streams, the interaction method according to some embodiments of the present disclosure further includes: determining one of the N sub-categories of audio data streams as the second display content in response to the triggering operation. That is, in these embodiments, one of the sub-categories is directly determined as the second display content based on the triggering operation. As an example, in response to the triggering operation of interface switching, the second display content can be directly determined as a music sub-category, that is, the data stream corresponding to music can be directly played after switching to the second display interface, and in addition, music recommendation can be made based on user parameters, historical data, etc., which are not limited here.

The interaction method according to some embodiments of the present disclosure may further include: in a case that the current display content is the data stream corresponding to auditory content, controlling the current display content and/or the data stream corresponding to auditory content in response to obtained voice control command. The current display content may be content in the interface currently being displayed. For example, with respect to the current data stream corresponding to auditory content shown in the second display interface as shown in FIG. 7 or FIG. 8, considering that the user in the current play state is likely to be in an application scenario convenient for an interaction operation, a voice control process can be provided for the application scenario corresponding to auditory consumption. As an example, the voice control command may include a wake-up word and a command word, and the mobile terminal such as shown in FIG. 2 can detect the wake-up word and the command word followed by the wake-up word based on the speaker, and perform semantic analysis on the command word to identify command content of the user, so as to make corresponding operations. For example, the operation may be a switch-to-play tab, to switch from a current music tab to a next radio tab. For another example, the operation can also be an interaction operation such as a next song, adding to favorites, etc., which is not described in detail here. Integrating a voice command function into the current display interface corresponding to auditory consumption content enables the interaction operation between users to be more intelligent and to more likely conform to the current application state of the users, thus improving the interaction experience of the users.

An implementation of a second display interface according to some embodiments of the present disclosure will be described below in conjunction with specific examples, wherein the second display interface is used to display a data stream corresponding to auditory content.

First, after switching to the second display interface, the data stream of the music sub-category may be played directly by default, that is, it is positioned as the music tab as shown in FIG. 7, and the background audio of a video in the first display interface may be played in the second display interface. In addition, in a case that the video in the first display interface does not include background music, a recommended music data stream, such as a recommended music list produced in the manner described above, may be directly played. In addition, before the background audio is played, the audio may be screened to determine whether the audio has an auditory consumption value. For example, the background audio of the video may be a dubbing corresponding to the video content or clipped music, which is not suitable for the auditory consumption by the user. In this case, playing the background audio can be avoided, but a music recommendation list is played, and through the above screening process, inappropriate content can be filtered out to better satisfy the entertainment need of the user.

In addition, in some cases, the background audio in the video may only include, for example, a drop of a song, and in this case, it is not appropriate to play only this part of the music on the second display interface. Therefore, song information corresponding to the music in the video may also be determined, and then the complete song can be played directly under the music tab of the second display interface, enabling the user to switch from an original video mode to the music mode, and also providing complete content of the music. This implementation may also help the user find music content of interest through video content. For example, in a process of browsing video content, the user may be interested in the background music configured in the video, and by switching to the music tab on the second display interface, the user may directly obtain the complete song and other related information of the music, such as a song title, a singer, lyrics, etc., such that the entertainment experience of the user is enriched.

The second display interface according to some embodiments of the present disclosure may also display data streams corresponding to real-time voice chat, so as to implement synchronous communication with family, friends or other drivers.

In addition, in the application scenario where the second display interface is a data stream corresponding to auditory content, the second display interface can also support a background play data stream. As an example, in a case that the current display interface is the second display interface, the user can enter a screen lock state through a screen lock operation, and continue to play the second display content in the background; in addition, brief information can be displayed on a screen lock interface to implement a global accompanying state and improve the user experience.

The interaction method according to some embodiments of the present disclosure may further include: acquiring a second dragging operation for a third movable control in the second display interface after displaying the second display content in the second display interface; and in response to the second dragging operation corresponding to dragging the third movable control to a second predetermined area in the second display interface, switching to the first display interface and continuing to display the first display content in the first display interface. Through the dragging operation on the third movable control in the second display interface, it is possible to switch back from the second display interface to the first display interface, and in addition, after switching back to the first display interface, the first display content described above may continue to be displayed, so as to realize the coherence of consumption content.

For example, before switching from the first display interface to the second display interface, the first video content is displayed in the first display interface, a triggering operation is detected at a first time point of the first video content, and the first display interface is switched to the second display interface in response to the triggering operation. Next, the data stream corresponding to auditory content, such as playing music, can be displayed on the second display interface. Next, after switching back from the second display interface to the first display interface in response to the second dragging operation for the third movable control, the first video content can continue to be played from the first time point of the first video content, such that the user can obtain consistent playing content before and after switching.

FIG. 9 shows a schematic diagram of a second display interface displaying a third movable control. As shown in FIG. 9, the movable control is displayed in the shape of a music turntable at a middle position of 412. After the dragging operation for the movable control is detected, the transitional content may be displayed on the second display interface. As an example, the transitional content includes the movable control, a hand icon and a direction identifier such as indicating an operation direction. Based on this, the user may switch back to the second display interface by dragging the movable control to the predetermined area. For example, the predetermined area may correspond to a position where the second movable control is displayed in the first display interface, for example, a position where the movable control 403 at a lower right corner of the first display interface is located as shown in FIG. 4.

By utilizing the interaction method according to the embodiment of the present disclosure, the steps of switching from a first display interface displaying first display content of a first type to a second display interface in response to a triggering operation, and displaying second display content of a second type in the second display interface after switching can be implemented, wherein the first display content of the first type is one of a data stream corresponding to visual content and a data stream corresponding to auditory content, and the second display content of the second type is the other one of the data stream corresponding to visual content and the data stream corresponding to auditory content, such that the interaction method according to the embodiments of the present disclosure can realize the effects of displaying both auditory and visual data streams in the same application program and switching between the two types of data streams through the triggering operation of the user, such that the application program can satisfy the accompanying needs of the users in various scenarios, and thus, the entertainment and user experience of the application program can be improved.

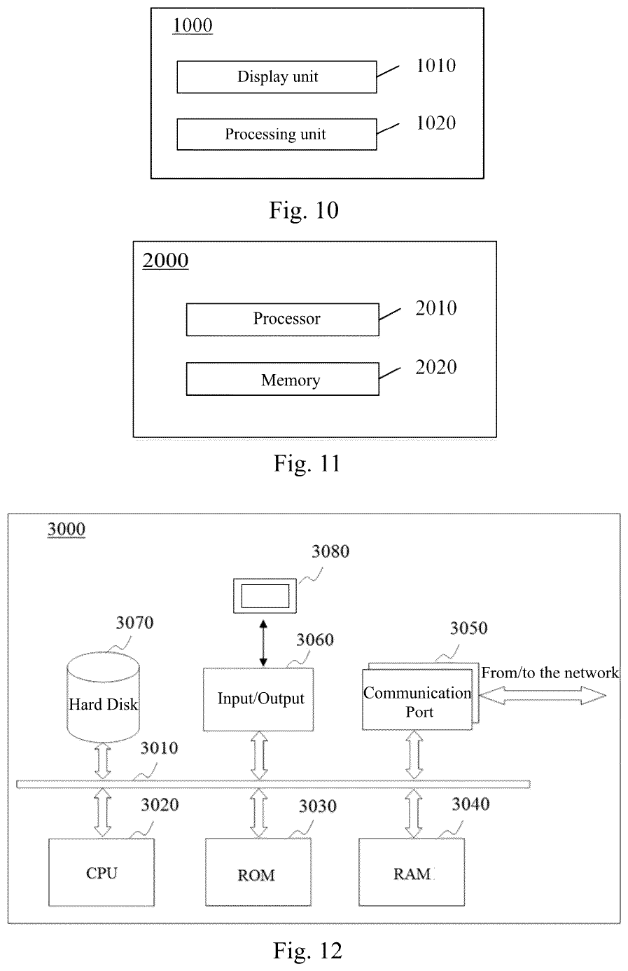

According to another aspect of the present disclosure, there is also provided an interaction device. FIG. 10 shows a schematic block diagram of an interaction device provided by at least some embodiments of the present disclosure. According to some embodiments of the present disclosure, the interaction device can implement the interaction method as described above based on functional units configured therein.

Specifically, as shown in FIG. 10, the interaction device 1000 may include a display unit 1010 and a processing unit 1020. The display unit 1010 may be configured to: display first display content corresponding to a first type in a first display interface of a target application. The processing unit 1020 may be configured to: switch from the first display interface to a second display interface of the target application in response to a triggering operation. The display unit 1010 is further configured to: display second display content corresponding to a second type in the second display interface. According to some embodiments of the present disclosure, the first display content of the first type is one of a data stream corresponding to visual content and a data stream corresponding to auditory content, and the second display content of the second type is the other one of the data stream corresponding to visual content and the data stream corresponding to auditory content, and at least one item of auditory content data in the data stream corresponding to auditory content is different from auditory content data corresponding to visual content data in the data stream corresponding to visual content.

Some functions implemented by the various units in the interface switching apparatus according to some embodiments of the present disclosure are described below.

According to some embodiments of the present disclosure, the first display content of the first type is the data stream corresponding to visual content, the second display content of the second type is the data stream corresponding to auditory content, and switching from the first display interface to the second display interface is a conversion from the data stream corresponding to visual content to the data stream corresponding to auditory content.

According to some embodiments of the present disclosure, the processing unit 1020 may be further configured to: determine the second display content according to a background audio associated with the first display content of the first type; or determine the second display content according to play information corresponding to the first display interface.

According to some embodiments of the present disclosure, the processing unit 1020 may be further configured to: directly determine the second display content in response to the triggering operation, wherein there is no corresponding relationship between the second display content and the first display content.

According to some embodiments of the present disclosure, the second display content is a predetermined audio, the predetermined audio including a background audio.

According to some embodiments of the present disclosure, in order to determine the second display content according to the background audio associated with the first display content of the first type, the processing unit 1020 may be configured to: acquire complete song information of the background audio, and determining the complete song information as the second display content.

According to some embodiments of the present disclosure, in order to display second display content corresponding to a second type in the second display interface, the processing unit 1020 may be configured to acquire a recommended audio data stream; and the display unit 1010 may be configured to take the recommended audio data stream as the second display content and automatically play the recommended audio data stream in the second display interface.

According to some embodiments of the present disclosure, the second type includes N sub-categories of audio data streams, N is an integer greater than 1, and the processing unit 1020 may be further configured to: determine one of the N sub-categories of audio data streams as the second display content in response to the triggering operation.

According to some embodiments of the present disclosure, the processing unit 1020 may be further configured to: switching to play the N sub-categories of audio data streams in the second display interface in response to a preset operation for the second display interface; or displaying a first movable control on the second display interface; and switching to play the N sub-categories of audio data streams in the second display interface in response to a dragging operation for the first movable control.

According to some embodiments of the present disclosure, the processing unit 1020 may be further configured to: in a case that the current display content is the data stream corresponding to auditory content, control the current display content and/or the data stream corresponding to auditory content in response to obtained voice control command.

According to some embodiments of the present disclosure, a second movable control is displayed in the first display interface, and in order to switch from the first display interface to the second display interface in response to a triggering operation, the processing unit 1020 may be configured to: acquire a first dragging operation for the second movable control; determine to trigger interface switching in response to the first dragging operation, the interface switching corresponding to switching from the first display interface to the second display interface.

According to some embodiments of the present disclosure, determining to trigger interface switching in response to the first dragging operation includes: determine to trigger interface switching in response to the first dragging operation corresponding to dragging the second movable control to a target area in the first display interface.

According to some embodiments of the present disclosure, the target area includes at least one first predetermined area located in the first display interface.

According to some embodiments of the present disclosure, the processing unit 1020 may be further configured to: acquire a second dragging operation for a third movable control in the second display interface after displaying the second display content in the second display interface; and in response to the second dragging operation corresponding to dragging the third movable control to a second predetermined area in the second display interface, switch to the first display interface and continue to display the first display content in the first display interface.

According to some embodiments of the present disclosure, the second predetermined area corresponds to a position where the second movable control is displayed in the first display interface.

According to some embodiments of the present disclosure, an operable control is displayed in the first display interface, and in order to switch from the first display interface to the second display interface in response to a triggering operation, the processing unit is configured to: determine to trigger interface switching in response to an operation duration for the operable control satisfying a time threshold, the interface switching corresponding to switching from the first display interface to the second display interface.

As an implementation, the display unit 1010 may include a display panel. Optionally, the display panel may be in the form of a liquid crystal display (LCD), an organic light-emitting diode display (OLED), etc. The display panel may be used to display information input by or provided to the user and various graphical user interfaces, which graphical user interfaces may be composed of graphics, texts, icons, videos and any combination thereof. In addition, the display unit 1010 may also include an audio circuit for displaying the data stream corresponding to auditory content, such as a background audio, a broadcast, etc.

As an implementation, the above-mentioned processing unit 1020 may be implemented as a logical operation center of a terminal device, which uses various interfaces and lines to link various functional units of the device, and executes various functions and processes data by running or executing software programs and/or modules stored in a memory and calling data stored in the memory. Optionally, the processing unit 1020 may be implemented as one or more processor cores. For example, the processing unit may be integrated with an application processor and a modem processor, wherein the application processor mainly processes an operating system, a user interface and an application program, etc., and the modem processor mainly processes wireless communication. It can be understood that the above-mentioned modem processor may not be integrated into the processing unit 1020.

In addition, it can be understood that the interaction device 1000 may further include a touch response unit for receiving touch data. As an implementation, the touch response unit may be implemented as a touch-sensitive surface or other input interfaces. For example, the touch-sensitive surface may also be configured as a touch screen (for example, the touch screen 204 shown in FIG. 2, which includes a touchpad 204-1 and a display 204-2) for collecting touch operations on or near the touch-sensitive surface by the user, such as operations of the user using any suitable objects or accessories such as a finger, a stylus, etc., and for driving corresponding functional units according to a preset program. Optionally, the touch-sensitive surface may include two parts: a touch detection apparatus and a touch control apparatus. The touch detection apparatus detects a touch orientation of the user, detects a signal brought by the touch operation and transmits the signal to the touch control apparatus. The touch control apparatus receives touch-related parameters from the touch detection apparatus, transforms the parameters into contact coordinates, then transmits the contact coordinates to, for example, the processing unit 1020, and then may receive instructions sent by the processing unit 1020 and execute the instructions. In addition, the touch-sensitive surface may be implemented as various types, such as resistive, capacitive, infrared and surface acoustic wave touchpads. In addition to the touch sensitive surface, the touch response unit may also include other input interfaces, for example. Specifically, other input interfaces may include, but are not limited to, one or more of a physical keyboard, function keys (such as volume control buttons, switch buttons, etc.), a trackball, a mouse, a joystick, etc. In addition, the touch-sensitive surface of the touch response unit may cover the above-mentioned display panel, and when the touch-sensitive surface detects a touch operation on or near it, the touch operation is transmitted to, for example, the processing unit 1020 to determine parameters of the touch operation, and then the processing unit 1020 may provide corresponding visual content or auditory content output on the display panel according to the parameters of the touch operation.

It is noted that in the interaction device according to the embodiment of the present disclosure, only the division of the functional units described above is exemplified, and in practical application, and in practical applications, the above functional units may be completed by different modules as needed, for example, an internal structure of the terminal device is divided into different units to complete all or part of the steps described above. In addition, the interaction device provided by the above-mentioned embodiment can implement the steps of the interaction method provided by the present disclosure, and the specific implementation processes refer to the method embodiment described above, which are omitted here.

According to yet another aspect of the present disclosure, there is also provided an electronic device, and FIG. 11 shows a schematic block diagram of the electronic device according to an embodiment of the present disclosure.

As shown in FIG. 11, the electronic device 2000 may include a processor 2010 and a memory 2020, wherein the memory 2020 has stored thereon a computer program (such as a program instruction, a code, etc.). The processor 2020 can execute the computer program to implement the steps of the interaction method as described above. As an example, the electronic device 2000 may be a terminal device on which a user logs in an account.

In at least one example, the processor 2010 may perform various actions and processes according to the computer program stored in the memory 2020. For example, the processor 2010 may be an integrated circuit chip with signal processing capability. The processor above may be a general-purpose processor, a digital signal processor (DSP), an application-specific integrated circuit (ASIC), a field programmable gate array (FPGA) or other programmable logic device, a transistor logic device, and a discrete hardware component. The various methods, steps and logic blocks disclosed in the embodiments of the present disclosure may be implemented or executed. The general-purpose processor may be a microprocessor or any conventional processor, and it may be an X86 architecture or an ARM architecture.

A computer program executable by a computer is stored in the memory 2020, and the computer program, when executed by the processor 2010, may implement the interaction method provided according to some embodiments of the present disclosure. The memory 2020 may be a volatile memory or a nonvolatile memory, or may include both the volatile and nonvolatile memories. The nonvolatile memory may be a read-only memory (ROM), a programmable read-only memory (PROM), an erasable programmable read-only memory (EPROM), an electrically erasable programmable read-only memory (EEPROM) or a flash memory. The volatile memory may be a random access memory (RAM), which is used as an external cache. By way of illustration but not limitation, numerous forms of RAMs are available, such as a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM) and a direct memory bus direct rambus random access memory (DR RAM). It should be noted that the memories described herein are intended to include, but are not limited to, these and any other suitable types of memories.

According to other embodiments of the present disclosure, the electronic device 2000 may further include a display (not shown) to implement visualization for a computer operator. For example, information such as the display content, the movable controls and data processing results in the process of implementing the interaction method described above may be displayed on the display, or information related to application programs may also be displayed, which is not limited here. In addition, the electronic device 2000 may also include necessary components such as an interaction interface, an input device, a communication unit, etc., for implementing information interaction between the computer and the operator and other devices, for example, the operator may modify the computer program through the input device.

As one of the exemplary implementations, the interface switching apparatus 1000 or the electronic device 2000 according to the present disclosure may also be implemented as a computing device as shown in FIG. 12.

FIG. 12 shows an architectural schematic diagram of an exemplary computing device according to an embodiment of the present disclosure. The computing device 3000 may include a bus 3010, one or more CPU 3020, a read-only memory (ROM) 3030, a random access memory (RAM) 3040, a communication port 3050 connected to a network, an input/output component 3060, a hard disk 3070, etc. A storage device in the computing device 3000, such as the ROM 3030 or the hard disk 3070, may store various data or files involved in the processing and/or communication of the interaction method provided by the present disclosure, as well as computer programs executed by the CPU. The computing device 3000 may also include a user interface 3080. For example, the user interface may be used to display the display content and movable controls, and may also receive the touch operation of the user through a touch-sensitive device thereon. Certainly, the architecture shown in FIG. 12 is only schematic. When implementing different devices, one or more components in the computing device shown in FIG. 12 may be omitted or required components may be added on the basis of the computing device shown in FIG. 12 according to actual needs, which is not limited here.

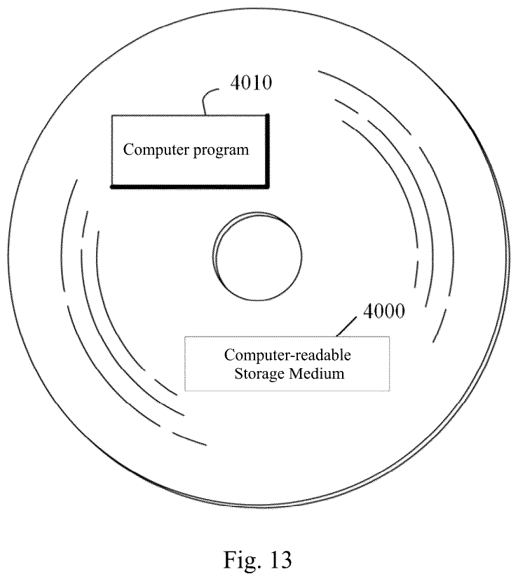

According to yet another aspect of the present disclosure, there is also provided a computer-readable storage medium, and FIG. 13 shows a schematic block diagram of the computer-readable storage medium provided by the present disclosure.

As shown in FIG. 13, a computer program 4010 is stored on a computer-readable storage medium 4000, wherein the computer program 4010, when executed by a processor, implements the steps of the interaction method as described above. In at least one example, the computer-readable storage medium 4000 includes, but is not limited to, a volatile memory and/or a nonvolatile memory. The volatile memory may include, for example, a random access memory (RAM) and/or a cache, etc. The nonvolatile memory may include, for example, a read-only memory (ROM), a hard disk, a flash memory, etc. For example, the computer-readable storage medium 4000 may be connected to a computing device such as a computer (for example, as shown in FIG. 12). Next, the interaction method provided by the present disclosure may be performed in a case that the computing device runs the computer program 4010 stored on the computer-readable storage medium 4000.

According to yet another aspect of the present disclosure, there is also provided a computer program product, including a computer program. In at least one example, the computer program, when executed by a processor, may implement the steps of the interaction method as described above.

Those skilled in the art will appreciate that the disclosure may be susceptible to variations and modifications. For example, various devices or components described above may be implemented by hardware, or may be implemented in software and firmware, or a combination of some of all of hardware, software and firmware.

In addition, while the present disclosure makes various references to certain units of a system according to embodiments of the present disclosure, any number of different units may be used and run on a client and/or the server. The units are merely illustrative, and different units may be used for different aspects of the system and the method.

Flowcharts are used in the present disclosure to illustrate the steps of the method according to the embodiment of the present disclosure. It should be understood that the preceding or following steps are not necessarily performed in the exact order shown. Instead, the various steps may be processed in a reverse order or simultaneously. Meanwhile, other operations may be added to these processes.

It can be understood by those of ordinary skill in the art that all or a part of the steps of the method described above may be implemented by a computer program instructing relevant hardware, which program may be stored in a computer-readable storage medium, such as a read-only memory, a magnetic disk or an optical disk, etc. Optionally, all or a part of the steps of the above-mentioned embodiment may also be implemented by one or more integrated circuits. Accordingly, the modules/units in the above-mentioned embodiments may be implemented in the form of hardware or may also be implemented in the form of software functional modules. The present disclosure is not limited to any specific form of combination of hardware and software.

Unless otherwise defined, all techniques used herein have the same meaning as those commonly understood by ordinary technical personnel in the field to which this disclosure belongs. It should also be understood that terms such as those defined in regular dictionaries should be interpreted as having meanings that are consistent with their meanings in the context of the relevant technology, and should not be interpreted in idealized or overly formal terms, unless explicitly defined here.

The above is an explanation of this disclosure and should not be considered as a limitation. Although several exemplary embodiments of the present disclosure have been described, those skilled in the art will easily understand that many modifications can be made to the exemplary embodiments without departing from the novel teaching and advantages of the present disclosure. Therefore, all these modifications are intended to be included within the scope of this disclosure as limited by the claims. It should be understood that the above is an explanation of the present disclosure and should not be considered limited to the specific embodiments disclosed, and the intention to modify the disclosed embodiments and other embodiments is included within the scope of the attached claims. This disclosure is limited by the claims and their equivalents.

1. An interaction method, comprising:
displaying first display content corresponding to a first type in a first display interface
switching from the first display interface to a second display interface in response to a triggering; and
displaying second display content corresponding to a second type in the second display interface, wherein the first display content of the first type is one of a data stream corresponding to visual content and a data stream corresponding to auditory content, the second display content of the second type is the other of the data stream corresponding to visual content and the data stream corresponding to auditory content, and wherein at least one item of auditory content data in the data stream corresponding to auditory content is different from auditory content data corresponding to visual content data in the data stream corresponding to visual content.

2. The method according to claim 1, wherein the first display content of the first type is the data stream corresponding to visual content, the second display content of the second type is the data stream corresponding to auditory content, and switching from the first display interface to the second display interface is a conversion from the data stream corresponding to visual content to the data stream corresponding to auditory content.

3. The method according to claim 2, further comprising:
determining the second display content according to a background audio associated with the first display content of the first type; or
determining the second display content according to play information corresponding to the first display interface.

4. The method according to claim 2, further comprising:
directly determining the second display content in response to the triggering, wherein there is no corresponding relationship between the second display content and the first display content.

5. The method according to claim 3, wherein the second display content is a predetermined audio, and the predetermined audio comprises the background audio.

6. The method according to claim 5, wherein the determining the second display content according to a background audio associated with the first display content of the first type comprises:
acquiring complete song information of the background audio, and determining the complete song information as the second display content.

7. The method according to claim 3, wherein the displaying second display content corresponding to a second type in the second display interface comprises:
acquiring a recommended audio data stream; and
determining the recommended audio data stream as the second display content, and automatically playing the recommended audio data stream in the second display interface.

8. The method according to claim 2, wherein the second type comprises N sub-categories of audio data streams, N is an integer greater than 1, and the method further comprises:
determining one of the N sub-categories of audio data streams as the second display content in response to the triggering.

9. The method according to claim 2, wherein the second type comprises N sub-categories of audio data streams, N is an integer greater than 1, and the method further comprises:
switching to play the N sub-categories of audio data streams in the second display interface in response to a preset operation for the second display interface; or
displaying a first movable control on the second display interface, and switching to play the N sub-categories of audio data streams in the second display interface in response to a dragging for the first movable control.

10. The method according to claim 2, further comprising:
when current display content is the data stream corresponding to auditory content, controlling the current display content and/or the data stream corresponding to auditory content in response to obtained voice control command.

11. The method according to claim 1, wherein a second movable control is displayed in the first display interface,
the switching from the first display interface to a second display interface in response to a triggering comprises:
acquiring a first dragging for the second movable control; and
determining to trigger interface switching in response to the first dragging, wherein the interface switching correspond to switch from the first display interface to the second display interface.

12. The method according to claim 11, wherein the determining to trigger interface switching in response to the first dragging comprises:
determining to trigger the interface switching in response to the first dragging corresponding to dragging the second movable control to a target area in the first display interface, wherein the target area comprises at least one first predetermined area located in the first display interface.

13. The method according to claim 11, further comprising:
acquiring a second dragging for a third movable control in the second display interface after displaying the second display content in the second display interface; and
in response to the second dragging corresponding to dragging the third movable control to a second predetermined area in the second display interface, switching to the first display interface and continuing to display the first display content in the first display interface.

14. The method according to claim 13, wherein the second predetermined area corresponds to a position where the second movable control is displayed in the first display interface.

15. The method according to claim 1, wherein an operable control is displayed in the first display interface,
the switching from the first display interface to a second display interface in response to a triggering comprises:
determining to trigger interface switching in response to an operation duration for the operable control satisfying a time threshold, wherein the interface switching corresponds to switch from the first display interface to the second display interface.

16. An interaction device, comprising:
a display unit configured to: display first display content corresponding to a first type in a first display interface of a target application;
a processing unit configured to: switch from the first display interface to a second display interface of the target application in response to a triggering; and
the display unit further configured to: display second display content corresponding to a second type in the second display interface, wherein the first display content of the first type is one of a data stream corresponding to visual content and a data stream corresponding to auditory content, the second display content of the second type is the other of the data stream corresponding to visual content and the data stream corresponding to auditory content, and wherein at least one item of auditory content data in the data stream corresponding to auditory content is different from auditory content data corresponding to visual content data in the data stream corresponding to visual content.

17. The interaction device according to claim 16, wherein the first display content of the first type is the data stream corresponding to visual content, the second display content of the second type is the data stream corresponding to auditory content, and switching from the first display interface to the second display interface is a conversion from the data stream corresponding to visual content to the data stream corresponding to auditory content.

18. The interaction device according to claim 17, wherein the processing unit is further configured to:
determine the second display content according to a background audio associated with the first display content of the first type; or
determine the second display content according to play information corresponding to the first display interface.

19. An electronic device, comprising a memory, a processor and a computer program stored in the memory, the computer program, when executed by the processor, cause the processor to:
display first display content corresponding to a first type in a first display interface;
switch from the first display interface to a second display interface in response to a triggering; and
display second display content corresponding to a second type in the second display interface, wherein the first display content of the first type is one of a data stream corresponding to visual content and a data stream corresponding to auditory content, the second display content of the second type is the other of the data stream corresponding to visual content and the data stream corresponding to auditory content, and wherein at least one item of auditory content data in the data stream corresponding to auditory content is different from auditory content data corresponding to visual content data in the data stream corresponding to visual content.

20. A nonvolatile computer-readable storage medium having a computer program stored thereon, wherein the computer program, when executed by a processor, implements the steps of the method according to claim 1.
